(19) United States
(12) Patent Application Publication
(10) Pub. No.: US 2021/0001653 A1
(43) Pub. Date: Jan. 7, 2021

(54) PRINTING APPARATUS WITH IMPROVED PRINT QUALITY CONTROL

(71) Applicant: MACSA ID, S.A., BARCELONA (ES)

(72) Inventors: Venkatesh SESHAIYA DORAISWAMY CHANDRASEKAR, Delft (NL); Martijn Joseph BOERKAMP, Delft (NL); Soufiane LEMKADDEM, Rotterdam (NL)

(73) Assignee: TOCANO HOLDING B.V., Delft (NL)

(21) Appl. No.: 16/316,129

(22) PCT Filed: Jul. 7, 2017
(86) PCT No.: PCT/NL2017/050457

§ 371 Date: Jan. 8, 2019

(30) Foreign Application Priority Data
Jul. 8, 2016 (NL) 2017141
Jul. 8, 2016 (NL) 2017142
Jul. 8, 2016 (NL) 2017143

(51) Int. Cl. B41J 29/393; B41M 5/26; B41J 2/44; B41J 2/475; B41M 99/00

(52) U.S. Cl. CPC B41J 29/393; B41M 5/26; B41M 99/00; B41J 2/475; B41J 2/442

(57) ABSTRACT

A printing apparatus, including: a feed, a printer, a controller configured to control operation of the printer, and a print quality sensor configured to acquire print quality information, where the controller is configured to adapt operation of the printer based on the print quality information. Further embodiment relates to a printing method, including the steps of: printing on a substrate in a printing operation; acquiring print quality information; and adaptation of the printing operation based on the print quality information.

The present invention relates to a printing apparatus with improved print quality control. Print quality is interpreted as the quality of a print on a printed object.

Conventional printing apparatuses use ink in various ways to print an image on a substrate, such as a paper. Commercially available printing apparatuses include toner-based printing apparatuses, liquid inkjet printing apparatuses, solid ink printing apparatuses and dye-sublimation printing apparatuses. The use of ink has several disadvantages, one of them being the limited capacity of the ink cartridges. Another disadvantage is that e.g. liquid ink might dry and clog the nozzle of a printing apparatus when the printing apparatus is not used for an extended period of time.

There have been attempts to provide inkless printing apparatuses, and prior art inkless printing apparatuses comprise e.g. thermal printing apparatuses that work by selectively heating regions of special heat-sensitive paper. Monochrome thermal printing apparatuses are used in cash registers, ATMs, gasoline dispensers and some older inexpensive fax machines.

WO-A1-2014/158019 of Applicant discloses an inkless printing apparatus that can be used with regular paper objects, i.e. that does not require the use of special heat-sensitive paper. This printing device is configured for the selective carbonization of at least a part of a surface of a paper object, more particularly of a sheet of paper, comprising receiving means for receiving the paper object, at least one laser for selectively heating one or more parts of the surface of said paper object to a level wherein the heated part of said surface at least partly carbonizes and thereby changes color, and control means for controlling the laser. The carbonization reaction on the one hand produces char that acts as a black pigment on the paper object. Furthermore, organic volatiles that are also produced by the carbonization reaction are condensed on the paper object where they function as an adhesive binder for the char, and in this way create a pigment on said paper object.

The printing device described in WO-A1-2014/158019 of Applicant obtained good results in a controlled testing environment. However, for commercial application, further challenges needed to be solved. It is desired that the printing apparatus is capable of dealing with a variety of circumstances, more in particular different paper types and paper conditions. Moreover, the permanency of the print should be of a high quality, even for the variety of circumstances encountered in practice. Permanency refers both to the print lasting over a long duration of time and resistance to being removed by abrasion.

The printing device of WO-A1-2014/158019 produces reaction products in the form of carbon based char and tar like compounds. Also byproducts such as smoke and organic volatiles are produced. The byproducts can condense on the paper object therefore causing unwanted color changes on the paper object. Furthermore, the byproducts can contaminate the laser optics or surfaces coming into contact with the reaction products. For example, when a transparent cover is used to obtain a low oxygen environment, this transparent cover may get dirty due to the byproducts, thereby also reducing the effectiveness of the laser beam that passes through said transparent cover. A consistent laser intensity is desirable in order to allow a controller to control the print quality. Last but not least, it is desired that the printing apparatus can be safely used, without any discomfort, e.g. due to odor or even smoke development.

US-A1-2005/104954 is considered the closest prior art. EP-A1-1396814, US-A1-2002/196473 and U.S. Pat. No. 5,963,244 are acknowledged as further prior art.

In this application, paper is interpreted as a material that most likely contains cellulose and has the ability to carbonize when exposed to a laser beam. This can for example be conventional copy papers used in conventional printers, but also cardboard boxes used for packaging or any composite that contains paper.

An object of the present invention is to provide a printing apparatus that is improved relative to the prior art and wherein at least one of the above stated problems is obviated.

Such objectives as indicated above, and/or other benefits or inventive effects, are attained according to the present disclosure by the assembly of features in the appended independent device claim and independent method claims. Further preferred embodiments are the subject of the dependent claims.

The present invention proposes a printing apparatus, comprising: a feed, a printer, a controller configured to control operation of the printer, and a print quality sensor configured to acquire print quality information, wherein the controller is configured to adapt operation of said printer based on the print quality information.

According to a preferred embodiment, the printing apparatus further comprises a laser configured to locally treat a substrate, wherein the print quality sensor is configured to acquire print quality information of the substrate at least partly treated by said laser.

According to a further preferred embodiment, the substrate comprises paper and the laser is configured to locally carbonize said paper.

According to a further preferred embodiment, the print quality sensor is configured to acquire print quality information during local carbonization of the substrate by said laser.

According to a further preferred embodiment, said controller is configured to stop carbonization of said substrate when a predetermined print quality has been obtained during printing.

According to a further preferred embodiment, the print quality sensor is a light sensor.

According to a further preferred embodiment, the printing apparatus further comprises a light source.

According to a further preferred embodiment, the print quality sensor is at least one of an infrared sensor, an image sensor and a thermal sensor.

According to a further preferred embodiment, the print quality sensor is configured to acquire print quality information of a spot wherein the laser hits or has hit the substrate.

According to a further preferred embodiment, the controller is further configured to acquire substrate characteristics and wherein the controller is configured to adapt operation of said printer based on said substrate characteristics.

According to a further preferred embodiment, said controller is configured to retrieve operation settings of said printer from a reference database based on the acquired substrate characteristics and/or the acquired print quality information.

According to a further preferred embodiment, said controller is configured to store operation settings of said printer and associated print quality information in said reference database.

The controller may also be configured to acquire substrate characteristics and to adapt operation of said printer based on said substrate characteristics, in combination with a printing apparatus comprising a print quality sensor configured to acquire print quality information, wherein the controller is configured to adapt operation of said printer based on the print quality information.

According to a further preferred embodiment, the printing apparatus further comprises a detector configured to detect characteristics of the byproducts and/or of reaction products formed in the substrate, and wherein the controller is configured to adapt operation of said printing apparatus based on the detected characteristics of the byproducts and/or of reaction products formed in the substrate.

According to a further preferred embodiment, the detector is arranged in a byproduct discharge, and preferably the detector is arranged downstream of a suction unit of said byproduct discharge.

According to a further preferred embodiment, the detector is arranged downstream of a filter that is arranged in said byproduct discharge.

According to a further preferred embodiment, the printing apparatus further comprises a pre-heater that is configured to pre-heat the substrate to a temperature between a temperature at which said substrate starts to change color and less than 20° C., preferably less than 15° C., more preferably less than 10° C. and most preferably less than 5° C. below said temperature where said substrate starts to change color.

According to a further preferred embodiment, the laser has an operational wavelength, and the printing apparatus comprises at least one further laser that has an operational wavelength that is different from the operational wavelength of the laser. In the following description preferred embodiments of the present invention are further elucidated with reference to the drawing, in which:

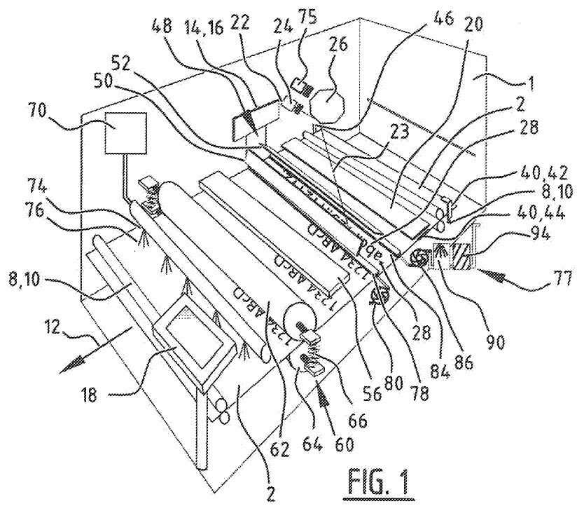

FIG. 1 is a schematic view of a printing apparatus according to the present invention;

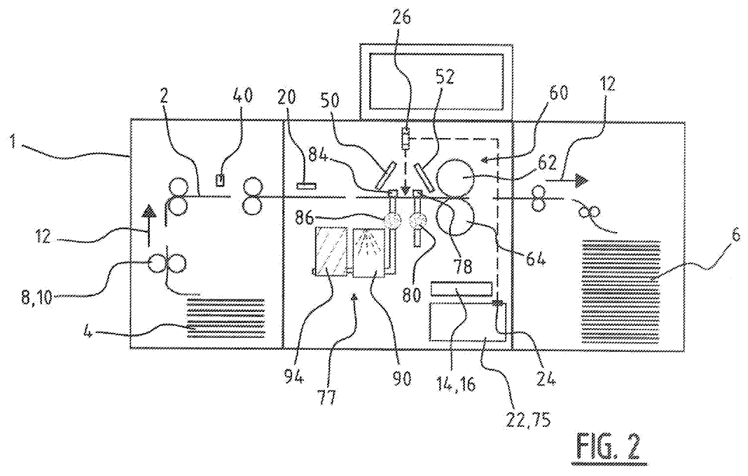

FIG. 2 is a side view of a printing apparatus according to FIG. 1 for the printing industry;

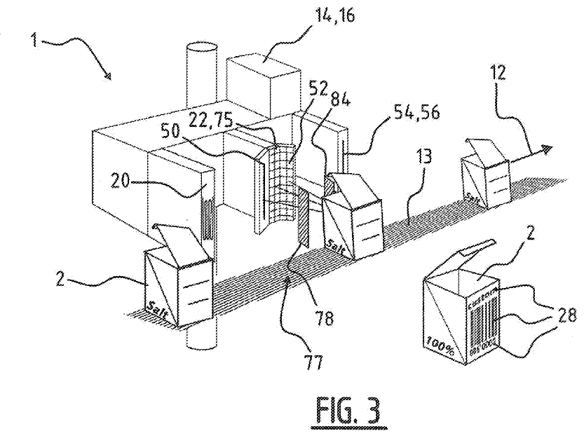

FIG. 3 is a perspective view of a printing apparatus according to FIG. 1 for the coding industry;

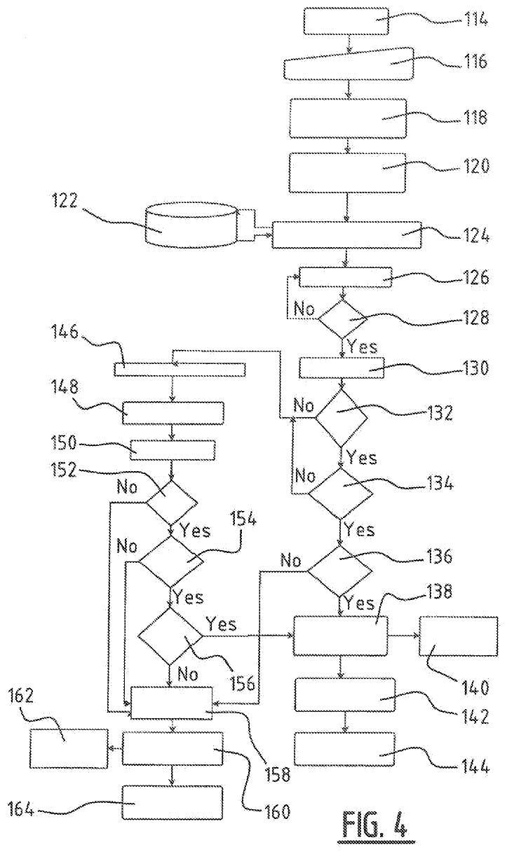

FIG. 4 is a flow diagram for operation of the printing apparatus according to the present invention;

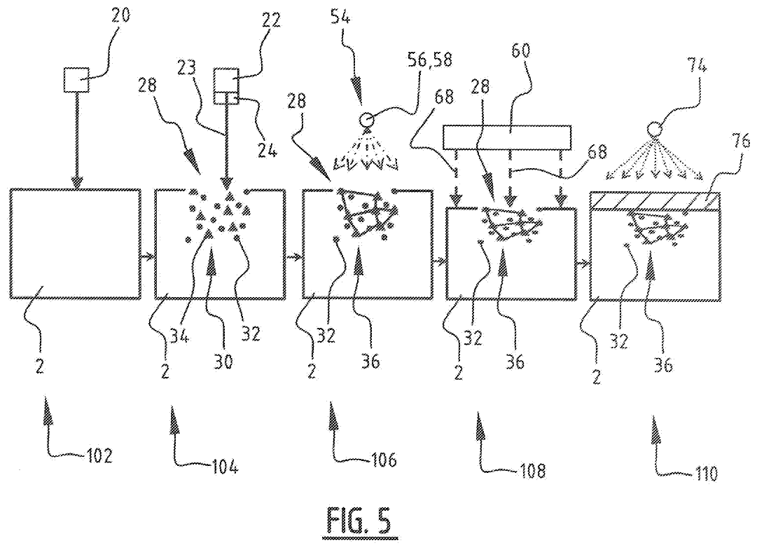

FIG. 5 is a schematic overview of operation steps of the printing apparatus according to the present invention;

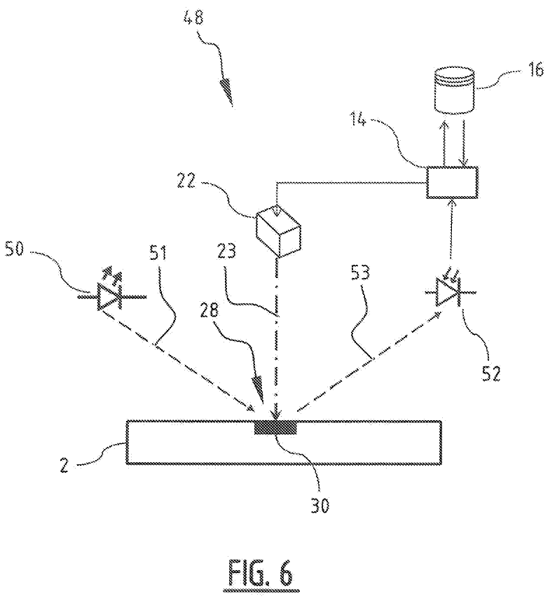

FIG. 6 is a schematic overview of a quality test unit of the printing apparatus according to the present invention;

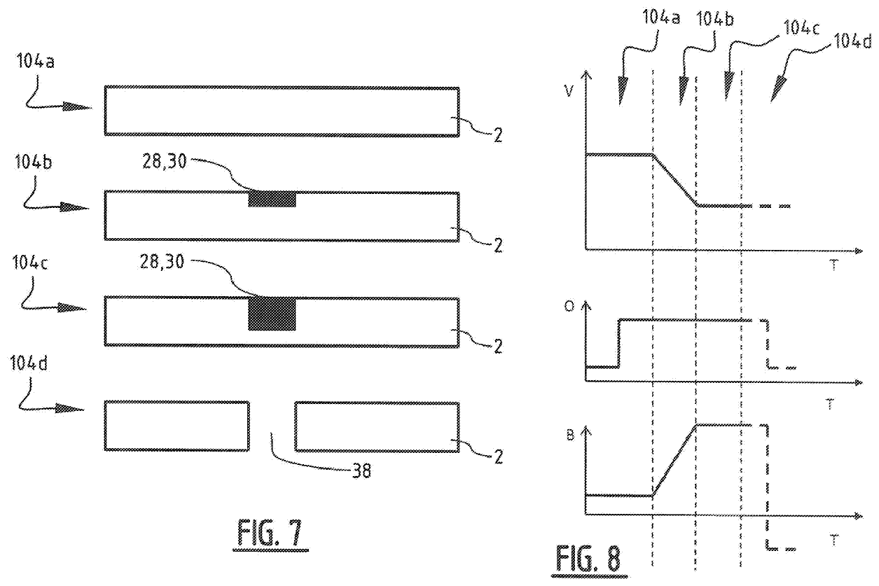

FIG. 7 shows schematic views of a paper product in successive carbonization steps;

FIG. 8 shows graphs corresponding to the carbonization steps of FIG. 7; and

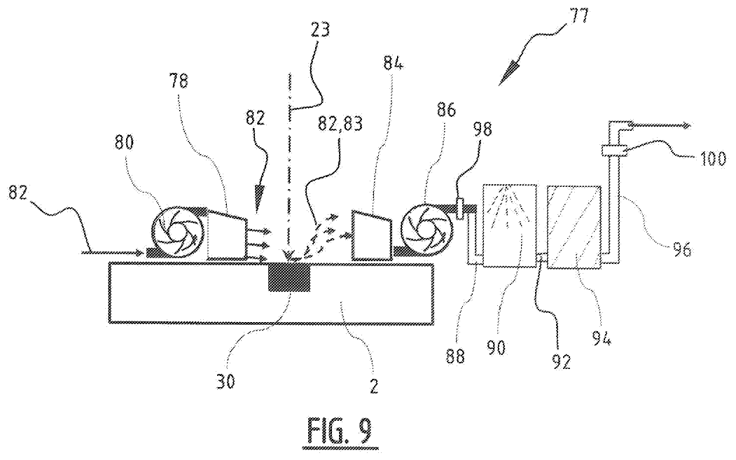

FIG. 9 is a schematic overview of a byproducts discharge of the printing apparatus according to the present invention.

The printing apparatus 1 shown in FIG. 1 is an inkless printing apparatus 1 wherein a paper object 2 is printed by carbonization of said paper object 2. It is however remarked that, although FIG. 1 shows a paper object 2 in the form of a sheet of paper 2, the paper object 2 may comprise paper 2 in any form or shape, especially including cardboard 2 and cardboard boxes 2. It is furthermore remarked that the invention is not limited to the paper substrate 2 described in the embodiments, but may also comprise the printing of other materials which undergo a contrast change on their surface and/or below the surface when heat or light is radiated on it. This contrast change enables a readable print on the material. Suitable materials comprise especially: paper, cardboard, cellulose based materials such as wood and cotton, textiles, glass, metal, plastics and mixture of the aforementioned materials with other materials in a sufficient quantity that their treatment leads to sufficient contrast change to enable carbonization.

Treatment by a laser 22 for most materials comprises carbonization.

Using a feed 8, e.g. comprising feed rollers 10, the substrate 2 is transported in a feed direction 12. Although substrates 2 in the form of cardboard boxes may be transported with roller tracks, also different type of feed 8, e.g. conveyor belts, may be used.

The printing apparatus 1 further comprises a controller 14 that comprises or is connected to a reference database 16. A user may provide the controller 14 with information using a user input 18.

The controller 14 is configured to acquire substrate characteristics and is configured to adapt operation of the printer, i.e. the laser 22, based on said substrate characteristics. The laser 22 is configured to emit a laser beam for locally carbonizing said substrate 2.

A pre-heater 20 may be provided for pre-heating the substrate 2 to a predetermined temperature below the carbonization temperature of the substrate 2. The advantages thereof will be explained with respect to steps 126 and 128 in FIG. 4. A pre-heater 20 may heat the substrate 2 in various ways, such as via radiative heating (e.g. illuminating the substrate using a light source), conductive heating (e.g. by placing the substrate 2 in contact with a hot surface) and convective heating (e.g. using hot air).

After the optional step of pre-heating said substrate 2, a radiative heat source 22 in the form of a laser is used for heating the substrate 2 to its carbonization temperature. The laser 22 emits a laser beam 23, which may be directed towards a to be printed part of said substrate 2 using a focus lens 24 and polygonal mirror 26, as also explained in WO-A1-2014/158019 of Applicant.

In order to prevent the focus lens 24 and/or polygonal mirror 26 from being contaminated due to byproducts 83, such as smoke, a byproducts discharge 77 may be arranged. The byproducts discharge 77 will be explained in more detail in FIG. 9. Byproducts within the meaning of this invention should be interpreted as undesired reaction products. These undesired reaction products may also comprise reaction products that are desirable in the paper, but that are undesirable when they emanate from the paper, such as carbon particles, carbon based volatiles, gases and other particulate matter.

When the laser beam 23 heats to be printed parts of said substrate 2 to a temperature at or above the carbonization temperature of the substrate 2, reaction products 30 form a print 28. The reaction products comprise carbon based char 32 and tar like compounds 34 (FIG. 5).

In order for the controller 14 to obtain relevant information regarding the characteristics of the substrate 2 and the environment, the printing apparatus 1 further comprises one or more than one substrate characteristics sensor 40, e.g. a substrate thickness detection sensor 42 and/or a substrate temperature sensor 44. Further information may be obtained by the controller 14 using one or more than one environment characteristics sensor 46, which may be a moisture and/or temperature sensor.

The thickness of the substrate 2 may be measured by using measuring magnetic resistance variation with respect to different substrate thicknesses, e.g. with a Voith LSC Caliper Sensor. A thinner substrate 2 should be marked with lower power to ensure that the surface marking without holes 38 can be met.

Surface quality and material of the substrate 2 can be measured by a gloss or roughness sensor which works based on measuring reflection from the substrate 2 for a given incident light, e.g. a Voith LSC Gloss Sensor. If the surface of the substrate 2 is very rough, there is a higher chance that the quality of the print 28 is not uniform, and a step of printing the substrate 2 with active feedback control (step 158 in FIG. 4) may be used.

The density of the substrate 2 may be measured using a contactless absorption sensor based on krypton radiation, such as a Voith LSC Basis Weight Sensor version 5112. If the substrate 2 has a low density, it should be marked with lower power to ensure that the surface marking without holes 38 can be met.

The moisture content of the substrate 2 can be measured by a transmission/reflection based moisture content detection sensor, such as Voith sensor version 5123. Moisture content also determines the power of the laser beam 23 and the speed of printing and it will be adjusted accordingly.

The color of the surface of the to be printed substrate 2 can be measured using a substrate color sensor. It can be a reflective sensor which measures the reflection of an incident light, such as a Voith LSC Color Sensor. The color of the substrate 2 will also vary the laser power and other process control parameters to reach the printing quality goals.

Based on the information the controller 14 obtained from the user via an input device 18 and further information obtained by the one or more than one substrate characteristics sensor 40 and/or by the one or more than one environment characteristics sensor 46, the controller 14 determines which settings are expected to provide the desired results. The controller 14 may consult a reference database 16. Typical settings that may be adjusted by the controller 14 are, amongst others, the laser power, the dwell time of the laser per dot, the duty cycle of the laser, the laser wavelength, the pre-heating temperature, the relative speed between substrate and laser, the pulse repetition frequency, the overlap distance and the focus.

The ‘laser power’ determines how much optical power is received from the laser 22 on the substrate 2. Increasing or decreasing the power of the laser beam 23 can change all the printing quality goals.

The ‘dwell time of laser per dot’ represents the amount of time spent by the laser beam 23 for each dot. The dwell time in combination with the power of the laser beam 23 determines the energy received by substrate 2 for a unit area.

The ‘duty cycle of the laser’ is the percentage of one period in which the laser is active with respect to the time when the laser is inactive.

The ‘laser wavelength’ used determines the effect that the laser beam 23 has on the substrate 2. The amount of power absorbed from the laser beam 23 is dependent on the absorption spectrum of the substrate 2.

The ‘pre-heating temperature’ can ensure that the speed of the printing can be faster since the substrate is at a higher starting temperature. Furthermore, the preheating ensures that the substrate 2 can be marked more in the surface thereby reducing the depth of carbonization. Another effect of pre-heating the substrate 2 is that it prevents a sudden increase in temperature from room temperature (approximately 20° C.) to the carbonization temperature (approximately 220° C.). A sudden temperature increase of this order will result in a thermal shock wave in the material of the substrate 2, which may cause the material to partly evaporate. This process is called ablation. Material that has become ablated from the substrate 2 is not available anymore for carbonization, and consequently ablation reduces the darkness that can be obtained in the printing process. Using pre-heating, ablation may be prevented, and consequently darker prints may be obtained.

In order to reduce ablation to a minimum, the substrate 2 is preferably pre-heated to a temperature that is several degrees lower than a temperature at which said substrate 2 will start to change color. For a paper substrate, color change will typically start at a temperature of approximately 180° C.

The ‘relative speed between substrate and laser’ represents the speed of the laser beam 23 as it scans across the substrate 2.

The ‘pulse repetition frequency’ determines the frequency at which the laser operates.

The ‘overlapping distance’ defines the distance between the center of a dot (or line) or the next adjacent dot (or line) made by the laser. Reducing the overlapping distance will reduce the depth of carbonization, and increase the resolution and the darkness of print.

Finally ‘focus’: the type of focus lens 24 used determines the size of the dot that is printed, which will thereby determine the resolution of the print. Higher resolution will enable higher quality of print 28.

A quality test unit 48, which will be explained in more detail using FIGS. 6-8, is provided for testing the quality of the print 28, so that the controller 14 obtains feedback if the real results match the expected results. The reference database 16 may be updated based on the results.

In the shown embodiment, the quality test unit 48 comprises a light source 50, e.g. a LED array, which emits light towards the print 28. Some light will be reflected by the print 28, and the print quality sensor 52 may be a light sensor that measures the intensity of light in the reflected light beam 53. Based on the light intensity of reflected light beam 53, the controller 14 is able to assess the carbonization, as will be explained using FIGS. 7 and 8.

Using a light source 50, it is possible to obtain increased accuracy, but the skilled person will understand that also reflected ambient light may be used. As the quality test unit 48 is normally enclosed in a housing of the printing apparatus 1, a light source 50 may be desired when the print quality sensor 52 is a light sensor 52. However, the skilled person will understand that the print quality sensor 52 may also be an infrared sensor, that measures the heat profile of the carbonized substrate for acquiring print quality information. In that case, a light source 50 may be absent.

In order to increase the permanency of the print 28, an electromagnetic radiator 54 may be used in order to cause the tar like compounds c1 to polymerize and interlink. The polymerized and interlinked tar compounds 36 are indicated in FIG. 5 has linked triangles. The electromagnetic radiator 54 may comprise a UV source 56 and/or an electron beam generator 58.

A further increase of the permanency of the print 28 may be obtained when the reaction products 30 are compressed into the substrate 2 using a compressing unit 60. The compressing unit 60 comprises a first compressing roller 62 and a second compressing roller 64 that may be pretensioned using a compression spring 66. The compressing rollers 62, 64 exert a compressive force 68 on the reaction products 30 that form the print 28 on said substrate 2.

A final step of even further increasing the permanency of the print 28 may comprise the step of using an applicator for adding a coating 76 on the reaction products 30 that form the print 28 on said substrate 2. The coating 76 preferably functions as a binder for the reaction products 30. The printing apparatus 1 comprises a coating reservoir 70, from which a conduit 72 transports coating 76 to coating nozzles 74 that are configured for spraying the coating 76 on the reaction products 30 that form the print 28 on said substrate 2.

Please note that the applicator can be used before or after printing. If used before printing, the applicator may apply an agent that promotes bonding of the reaction products 30 in a successive printing step, i.e. carbonization step.

In order to prevent the focus lens 24 and/or polygonal mirror 26 from being contaminated from byproducts 83, such as smoke, a byproducts discharge 77 (FIG. 9) may be arranged. This byproducts discharge 77 may also be useful to prevent any discomfort or health risks for a user, e.g. due to odor or even smoke development.

FIGS. 2 and 3 show embodiments of a printing apparatus 1 according to the present invention for the printing industry (FIG. 2) and the coding industry (FIG. 3) respectively. Like reference numbers as in FIG. 1 are used for the features shown in FIGS. 2 and 3. Therefore a detailed description of these features is omitted here.

The printing apparatus 1 of FIG. 2 is configured to print large amounts of sheets of substrate 2. Substrates 2, such as sheets of paper are taken from the input stack of paper 4, and transported along the feed direction 12 through the printing apparatus 1. The printed sheets of paper are collected in an output stack of paper 6.

On the other hand, the printing apparatus 1 of FIG. 3 is a coding printing apparatus configured for printing prints 28 on cardboard boxes that form the substrates 2. The cardboard boxes 2 are transported in the feed direction 12 using a conveyor 13.

In order to elucidate the operation of the printing apparatus according to the invention, successive operating steps will be described using flow diagram of FIG. 4. The operation starts with a ‘step of the feed moving the to be printed substrate forward’ 114.

It is necessary that the controller 14 of printing apparatus 1 is informed about the substrate characteristics, such as thickness, surface roughness, temperature, moisture, etc. Some information, such as the chosen substrate type, may be indicated in the optional ‘step of user inputting substrate characteristics’ 116. Other substrate characteristics, such as the moisture level and temperature of said substrate, are obtained by the ‘step of substrate characteristics sensors acquiring information’ 118.

The operation further comprises the ‘step of environment sensors acquiring information’ 120, which may be performed simultaneously or following step 118. One or more than one environment sensor acquires information about the environment, such as temperature and moisture levels.

Based on the information about the actual characteristics of the substrate and the environment, the operation performs a ‘step of the control unit acquiring information from reference database’ 122. Information of earlier test results and pre-set conditions may be stored in this reference database 16.

Subsequently, the operation is continued with the ‘step of the control unit setting characteristics such as laser speed, laser power and overlap distance’ 124.

The ‘step of pre-heating the to be printed substrate’ 126 and ‘step of checking if the substrate is pre-heated to a predetermined temperature below the carbonization temperature of the substrate’ 128 aim to bring the substrate 2 at a desired elevated temperature. The radiative heating source, i.e. laser 22, now only has to increase the temperature of the substrate 2 from the elevated temperature already obtained by the pre-heating to the carbonization temperature of the substrate 2. Due to the pre-heating, the printing speed of the printing apparatus 1 is improved relative to a printing apparatus wherein the substrate 2 would have to be heated from a room temperature of about 20° C. to the carbonization temperature of the substrate 2.

The pre-heater 20 is preferably configured to pre-heat the substrate 2 to a temperature between a temperature at which said substrate starts to change color and less than 20° C., preferably less than 15° C., more preferably less than 10° C. and most preferably less than 5° C. below said temperature where said substrate starts to change color. In this way, ablation is reduced to a minimum and high quality dark prints may be obtained. However, because the pre-heating does not exceed the temperature at which the substrate 2 starts to change color, also a high contrast between the dark print and the original color of the substrate 2 may be obtained.

Next, the operation tests the quality of the print 28 based on a sequence of steps, comprising first a ‘step of printing test dots’ 130, followed by a ‘step of measuring and checking if the desired darkness is obtained’ 132 and a ‘step of measuring and checking if the substrate is free of holes’ 134.

Only if a ‘step of measuring and checking if the consistency of the darkness is okay’ 136 provides positive results, the operation continues with a ‘step of printing the entire substrate with determined and set print characteristics (such as laser power, overlap, print speed, etc.)’ 138.

If the ‘step of measuring and checking if the consistency of the darkness is okay’ 136 would provide negative results, the operation continues with a feedback controlled operation. This feedback control comprises the further steps of a ‘step of printing feedback controlled dots’ 146, a ‘step of the control unit setting characteristics such as laser speed, laser power and overlap distance’ 148, a ‘step of printing test dots’ 150, a ‘step of measuring and checking if the desired darkness is obtained’ 152 and a ‘step of measuring and checking if the substrate is free of holes’ 154. Finally, a ‘step of measuring and checking if the consistency of the darkness is okay’ 156 is performed. Again, only if the ‘step of measuring and checking if the consistency of the darkness is okay’ 156 provides positive results, the operation continues with a ‘step of printing the entire substrate with determined and set print characteristics (such as laser power, overlap, print speed, etc.)’ 138.

Preferably, one or more of the ‘steps of discharging byproducts’ 140 (FIG. 9), and ‘steps of increasing permanency’ 142 (FIG. 5) are executed before the ‘step of finishing printing operation’ 144.

If the ‘step of measuring and checking if the consistency of the darkness is okay’ 156 would provide negative results, the process continues with the ‘step of printing the entire substrate with active feedback control’ 158.

Preferably, one or more of the ‘steps of increasing permanency’ 160 (FIG. 5) and ‘steps of discharging byproducts’ 162 (FIG. 9) are executed before the ‘step of finishing printing operation’ 164.

It is remarked that the ‘steps of increasing permanency’ 142, 160 are identical for both the ‘normal’, i.e. step 138, and ‘active feedback controlled’, i.e. step 158, printing of the substrate 2. Likewise, the ‘steps of discharging byproducts’ 140, 162 are identical for both the ‘normal’, i.e. step 138, and ‘active feedback controlled’, i.e. step 158, printing of the substrate 2.

The ‘steps of increasing permanency’ 142, 160 are now further explained using FIG. 5. The successive steps preferably comprise a pre-heating step 102, a carbonization step 104, an irradiating step 106, a compressing step 108 and a coating step 110.

In the pre-heating step 102, the pre-heater 20 heats the surface of the to be printed substrate 2 to a desired temperature below the carbonization temperature of said substrate 2. Pre-heating the substrate 2 increases the speed of printing, because a smaller temperature rise is required to obtain the carbonization temperature of the substrate 2.

In the next carbonization step 104, the laser 22 emits a laser beam 23 that increases the temperature of the substrate 2 to the carbonization temperature thereof. The carbonization process will start, and carbon based char 32 (denoted with circles in the FIG. 5) and tar like compounds 34 (denoted with triangles in FIG. 5), are formed as reaction products 30. These reaction products 30 have a dark color that contrasts with the substrate 2, and in this way form the print 28 on the substrate 2.

In the irradiating step 106, the electromagnetic radiator 54, which may be a UV source 56 or an electron beam generator 58, emits electromagnetic waves towards the reaction products 30. This causes the tar like compounds 34 to polymerize and form links with each other. A chemical reaction produces products which increase the cohesiveness and adhesiveness of the print 28 within the substrate 2 matrix. The polymerized and interlinked tar compounds 36 (denoted with linked triangles in FIG. 5) are bonded and therefore better resistant against wear, thereby further increasing the permanency of the print 28.

The compressing step 108 comprises the step of a compressing unit 60 exerting a compressive force 68 on the substrate 2, thereby also compressing the reaction products 30. The compression will increase the density of the reaction products 30 and interlocks the reaction products 30 with the substrate 2. The reaction products 30 will function as a binder for the carbon based char 32 and thereby improves the permanency of the print 28 on said substrate 2.

Preferably, the compressing unit 60 that forms the compressor is configured to vibrate. A vibrating compressing unit 60 creates frictional heat, and the combination of pressure and heat improves the permanency of the print.

A printing method according to the invention comprises the steps of:
at least partially carbonizing a substrate with a laser 22, thereby forming at least tar like compounds 34 as reaction products 30 of the carbonizing in said substrate 2;
compressing the reaction products 30 onto the substrate 2; and
substantially simultaneously with said compressing step, supplying energy to the reaction products 30 that are being pressed onto the substrate 2. By supplying energy during the compressing of the reaction products 30 onto the substrate 2, the tar like compounds 34 that are formed as reaction products 30 will polymerize and interlink. In this way, the permanency of the print 28 is increased.

The step of supplying energy to the reaction products 30 that are pressed onto the substrate 2 preferably comprises irradiating said reaction products with electromagnetic radiation. The electromagnetic radiation may comprise ultraviolet (UV) light or infrared (IR) radiation.

The step of supplying energy to the reaction products 30 that are pressed onto the substrate 2 may also comprise vibrating said substrate 2. Vibrating said substrate 2 will cause frictional heat due to friction between the substrate 2 and the compressing unit 60. The combination of pressure and heat further improves the permanency of the print 28.

The vibration frequency may be higher than 10 kHz, preferably higher than 15 kHz, and more preferably higher than 20 kHz. A frequency from 20 kHz and higher exceeds the upper audible limit of human hearing, and therefore has the additional benefit that the operation of the compressor of the printing apparatus is silent to humans.

The compressing roller 62, 64 of compressing unit 60 preferably comprises a material with an elastic modulus that is equal to or lower than an elastic modulus of the substrate 2. If this condition is met, the reaction products 30 may be pressed onto the substrate 2 without calenderizing the substrate 2. The substrate 2 normally being paper or cardboard, the elastic modulus of the compressing roller 62, 64 is preferably less than 3 GPa. A suitable material is Teflon.

By adding a coating to the outer circumferential surface of the compressing roller 62, 64, adherence of the reaction products 30 to the compressing roller 62, 64 may be prevented. The coating may be formed as an oleophobic coating or as an aluminum sheet.

Finally, a coating step 110 may be performed, wherein a coating 76 is arranged on the print 28. This coating 76 may function as a binder between the reaction products 30, binding them to the substrate 2 and creating a barrier to prevent the print 28 from being smudged.

Although the best results are obtained if the carbonization step 104 is followed by all three steps of irradiating 106, compressing 108 and coating 110, the skilled person will understand that each independent step already contributes to an increase of the permanency of the print 28. Also the pre-heating step 102, that contributes to an increased speed of printing, is optional.

FIG. 6 shows a quality test unit 48. A light source 50, e.g a LED array, emits light. The light beam 51 emitted from this light source 50 reflects on the print 28 and the reflected light beam 53 is received by a print quality sensor 52 that is a light sensor. By comparing the intensity of the light emitted from the light source 50 and the intensity of the light received by the light sensor, i.e. print quality sensor 52, it is possible to determine the amount of light absorbed by the print 28. Based on this information, it is possible to determine different phases 104a-104d of the carbonization step 104.

As indicated in FIG. 6, the quality test unit 48 is capable of testing during the carbonization step 104, i.e. while the laser 22 emits a laser beam 32 towards the substrate 2 and reaction products 30 are formed, defining a print 28.

A printing method according to the invention comprises the steps of printing on a substrate 2 in a printing operation, acquiring print quality information, and adapting the printing operation based on the print quality information.

In a preferred embodiment, the step of printing a substrate 2 comprises locally treating said substrate 2 with the laser 22, and the print quality information is acquired of the substrate 2 that is at least partly treated by said laser 22.

In a further preferred embodiment, the step of acquiring print quality information comprising acquiring said print quality information during local carbonization of the substrate 2.

The method preferably further comprises the step of stopping carbonization of said substrate 2 when a predetermined print quality has been obtained.

In a preferred embodiment, the printing apparatus has at least one further laser 75. The laser 22 has an operational wavelength, and the further laser 75 has an operational wavelength that is different from the operational wavelength of the laser 22. The printing apparatus 1 may have more than one laser 22 of a first type, each having a first operational wavelength, and one or more than one further laser 75, each having an operational wavelength that is different from the operational wavelength of the one or more than one laser 22 of the first type.

For most types of substrate 2, including paper and cardboard, the absorption of laser energy by said substrate 2 is lower at a lower operational wavelength of said laser. Consequently, higher wavelengths such as 10600 nm are more suitable for laser marking than 1 1550 nm wavelength, because feedback based quality control may not be necessary. However, lasers with a lower operational wavelength are more advanced and often cheaper.

In a preferred embodiment, the printing method comprising the steps of:
using a print 28 made by a first laser 22 to acquire print quality information;
adaptation of the printing operation based on the print quality information of said print 28 made by said first laser 22;
reaching a desired print quality; and
printing with a second laser 75 after the desired print quality has been obtained.

Typically, the first laser 22 emits a higher wavelength than the second laser 75. In this way, an advanced laser 75 may be used for the major part of the print 28, while the advantages of a laser 22 with a higher operational wavelength are used to efficiently acquire print quality information.

The carbonization step 104 comprises four phases: a first phase 104a, a second phase 104b, a third phase 104c and a fourth phase 104d (FIG. 7).

In the first phase 104a of carbonization step 104, the laser beam 23 is still warming up the substrate 2 to the carbonization temperature thereof.

In the second phase 104b of carbonization step 104, carbonization has just started, and print 28 will still have a brown color, and is still getting darker, i.e. it is changing color from brown towards black.

In the third phase 104c of carbonization step 104, the reaction products 30 reach deeper into the substrate 2, and the print 28 has obtained its maximum darkness. In this third phase 104c, the carbonization is preferably stopped.

In the fourth phase 104d of carbonization step 104, the laser beam 23 has burnt through the substrate 2, leaving a hole 38, which is undesirable.

FIG. 8 show three graphs, each having the time T on the x-axis. In the top graph, the V indicates the voltage of a photodiode of the light sensor, i.e. print quality sensor 52. In the center graph, O indicates the output of the laser. In the lower graph, B indicates the percentage blackness of the print 28.

In the first phase 104a, the substrate 2 is still it is original color, e.g. white, and reflects most light of light beam 51 that is emitted by the light source 50. In the second phase 104b, the print 28 is getting darker, which can be seen in B increasing in the lower graph. Consequently, less light is getting reflected towards the print quality sensor 52, i.e. the light sensor. This results in the voltage V of the photodiodes of the light sensor decreasing. Once the print 28 is not really getting darker anymore, the voltage V will get constant again (third phase 104c). Both V and B show a flat line.

In the third phase 104c, optimal darkness of the print 128 is obtained. When the darkness B does not increase anymore, and the voltage V is getting constant, the controller 14 makes sure the laser beam 23 is stopped from heating that specific spot on the substrate 2.

The ‘steps of discharging byproducts’ 140, 162 are now further explained using FIG. 9. The carbonization reaction on the one hand produces reaction products 30 that are either gaseous or mixed within the air, such as char like substances, and byproducts such as smoke and organic volatiles. These gases and airborne particles will contaminate the substrate 2 when condensing back to the substrate 2. If the byproducts 83 contact the substrate 2 after emanating from the substrate 2, they can condense and cause a hazy glow next to the print. Hazy glow may also occur due to the heat energy stored in the byproducts 83 and hence therefore it is desirable that they are removed from the print area without allowing it to interact with the print area. Preferably, the removal is performed in a direction substantially perpendicular to the plane of the print area in order to eliminate the chance of interaction. Furthermore, the gases and airborne particulate matter will contaminate surfaces, such as but not limited to optical components of the laser 22, such as focus lens 24. Byproducts discharge 77 comprises a blower 78 with a blowing pump 80 configured to blow substantially clean gas 82 towards the print 28, thereby moving any byproducts 83 such as smoke away from the to be printed area on the substrate 2. The byproducts 83 are drawn into a suction unit 84 that is powered by a suction fan 86. The byproducts 83 are transported from the suction unit 84 via a conduit 88 towards a water scrubber 99. The water scrubber 99 serves to sediment the particulate matter that is present in the byproducts 83. This can be later collected and cleaned from the printing apparatus 1. The byproducts 83 are transported via a conduit 92 from the water scrubber 99 towards an activated carbon filter 94 that serves to remove any odours arising from organic volatiles present in the byproducts 83. This way, clean odourless gases can be passed out of the printing apparatus 1 via outlet conduit 96. Additional process steps may be added to ensure that the gases in outlet conduit 96 meet the air quality standards required in offices/relevant environments where such printing apparatuses 1 are used. Instead of or in addition to activated carbon filter 94, a (not shown) electrostatic filter may be applied.

It is to be noted that the when additional gas is pumped though blower 78, it removes the oxygen and other gases present in the vicinity of carbonization and may create a low oxygen environment. This has an additional desired effect of preventing smoke 83 from forming. The low oxygen environment can also be created by creating a vacuum using suction unit 84. Furthermore, a transparent cover can be placed on top of the blower 78 and suction unit 84, such that the components of the printing apparatus 1 are completely sealed off from the print area.

The printing apparatus 1 may further comprise a detector 98, 100 configured to detect characteristics of the byproducts 83 and/or of reaction products 30 formed in the substrate 2. The controller 14 is preferably configured to adapt operation of said printing apparatus 1 based on the detected characteristics of the byproducts 83 and/or of reaction products 30 formed in the substrate 2. Both detectors 98, 100 shown in FIG. 9 are arranged in the byproduct discharge 77. The first detector 98 is arranged downstream of said suction unit 84, and the second detector 100 is arranged downstream of filter 94.

The function of detectors 98, 100 is to understand the composition, temperature and other relevant properties of the reaction products 30 and/or byproducts 83 which consist of smoke, organic volatiles and other gases. The controller 14 may stop or optimize the carbonization reaction to produce the least amount of byproducts 83 or to stop the printing completely if the level of byproducts 83 produced is too high for the filters 94 to handle or detect if the filters 94 are clogged or damaged. For this latter function, detector 100, that is arranged downstream of filter 94, is used.

Although they show preferred embodiments of the invention, the above described embodiments are intended only to illustrate the invention and not to limit in any way the scope of the invention. Accordingly, it should be understood that where features mentioned in the appended claims are followed by reference signs, such signs are included solely for the purpose of enhancing the intelligibility of the claims and are in no way limiting on the scope of the claims. Furthermore, it is particularly noted that the skilled person can combine technical measures of the different embodiments while leaving out others. The scope of the invention is therefore defined solely by the following claims.

1-27. (canceled)

28. Printing apparatus, comprising:
a feed;
a printer;
a controller configured to control operation of the printer;
a print quality sensor configured to acquire print quality information; and
wherein the controller is configured to adapt operation of said printer based on the print quality information.

29. Printing apparatus according to claim 28, further comprising:
a laser configured to locally treat a substrate;
wherein the print quality sensor is configured to acquire print quality information of the substrate at least partly treated by said laser.

30. Printing apparatus according to claim 29, wherein the substrate comprises paper and the laser is configured to locally carbonize said paper.

31. Printing apparatus according to claim 28, wherein the print quality sensor is configured to acquire print quality information during local carbonization of the substrate by said laser.

32. Printing apparatus according to claim 28, wherein said controller is configured to stop carbonization of said substrate when a predetermined print quality has been obtained.

33. Printing apparatus according to claim 28, further comprising a light source, and wherein the print quality sensor is a light sensor.

34. Printing apparatus according to claim 28, wherein the print quality sensor is an infrared sensor, and/or an image sensor, and/or a thermal sensor.

35. Printing apparatus according to claim 29, where the print quality sensor is configured to acquire print quality information of a spot wherein the laser hits or has hit the substrate.

36. Printing apparatus according to claim 28, wherein the controller is further configured to acquire substrate characteristics and wherein the controller is configured to adapt operation of said printer based on said substrate characteristics.

37. Printing apparatus according to claim 28, wherein said controller is configured to retrieve operation settings of said printer from a reference database based on the acquired substrate characteristics and/or the acquired print quality information.

38. Printing apparatus according to claim 37, wherein said controller is configured to store operation settings of said printer and associated print quality information in said reference database.

39. Printing apparatus according to claim 28, further comprising:
a detector configured to detect characteristics of the byproducts and/or of reaction products formed in the substrate; and
wherein the controller is configured to adapt operation of said printing apparatus based on the detected characteristics of the byproducts and/or of reaction products formed in the substrate.

40. Printing apparatus according to claim 39, wherein the detector is arranged in a byproduct discharge, and/or downstream of a suction unit of said byproduct discharge, and/or downstream of a filter that is arranged in said byproduct discharge.

41. Printing apparatus according to claim 28, further comprising a pre-heater that is configured to pre-heat the substrate to a temperature between a temperature at which said substrate starts to change color and less than 20° C., below the temperature where said substrate starts to change color.

42. Printing apparatus according to claim 29, wherein the laser has an operational wavelength, and the printing apparatus comprises at least one further laser that has an operational wavelength that is different from the operational wavelength of the laser.

43. Printing method, comprising the steps of:
printing on a substrate in a printing operation;
acquiring print quality information; and
adapting the printing operation based on the print quality information.

44. Printing method according to claim 43, wherein:
printing a substrate comprises locally treating said substrate with a laser; and
the print quality information is acquired of the substrate that is at least partly treated by said laser.

45. Printing method according to claim 43, wherein the step of acquiring print quality information comprises acquiring said print quality information during local carbonization of the substrate.

46. Printing method according to claim 43, further comprising the step of stopping carbonization of said substrate when a predetermined print quality has been obtained.

47. Printing method according to claim 43, wherein the step of printing on the substrate is preceded by a step of pre-heating said substrate to a temperature between a temperature at which said substrate starts to change color and less than 20° C., below the temperature where said substrate starts to change color.

48. Printing method according to claim 43, further comprising the steps of:
using a print made by a first laser to acquire print quality information;
adaptation of the printing operation based on the print quality information of said print made by said first laser;
reaching a desired print quality; and
printing with a second laser after the desired print quality has been obtained.

47. Printing method according to claim 48, wherein the first laser emits a higher wavelength than the second laser.
